(19) United States
(12) Patent Application Publication
(10) Pub. No.: US 2026/0292090 A1
(43) Pub. Date: Sep. 24, 2026

(54) IMAGE FORMING APPARATUS, SETTING MANAGEMENT METHOD, AND STORAGE MEDIUM

(71) Applicant: Konica Minolta, Inc., Tokyo (JP)

(72) Inventors: Hiroshi Sugiura, Toyokawa-shi (JP); Kazuhiro Tomiyasu, Toyokawa-shi (JP)

(73) Assignee: Konica Minolta, Inc., Tokyo (JP)

(21) Appl. No.: 19/568,853

(22) Filed: Mar. 17, 2026

(30) Foreign Application Priority Data
Mar. 18, 2025 (JP) 2025-043020

(51) Int. Cl. H04N 1/00

(52) U.S. Cl. CPC H04N 1/00973; H04N 1/00244; H04N 1/00408; H04N 2201/0094

(57) ABSTRACT

An image forming apparatus including a hardware processor that: acquires setting information set in another image forming apparatus; sets the acquired setting information; determines whether or not setting of a setting item related to the acquired setting information is necessary; and prompts setting of a setting item for which setting is determined to be necessary.

### CROSS-REFERENCE TO RELATED APPLICATION

The entire disclosure of Japanese Patent Application No. 2025-043020, filed on Mar. 18, 2025, including description, claims, drawings and abstract is incorporated herein by reference.

### BACKGROUND OF THE INVENTION

### Technical Field

The present disclosure relates to an image forming apparatus, a setting management method, and a storage medium.

### Description Of Related Art

In recent years, image forming apparatuses such as multifunction peripherals, printers, and copiers have many functions such as a copy function, a printer function, a scanner function, and a FAX function. When starting to use a certain function, an image forming apparatus may require initial setup (initial setting). For example, when an image forming apparatus has a function of using a network, there are cases where it is necessary to input server information, address information, and the like.

An image forming apparatus has a function of presenting various settings in a wizard format at the time of initial setup to guide a user, thereby completing minimum basic settings.

For example, Japanese Unexamined Patent Publication No. 2006-139422 discloses a configuration in which answers to a plurality of question items are used to select a plurality of setting modules that needs to be set, and a setup wizard is created. The plurality of question items are used to inquire about the function to be used and the content of the network environment.

Further, Japanese Unexamined Patent Publication No. 2021-13140 discloses a configuration in which a setting value actually used in another image forming apparatus is indicated as a recommended setting value at the time of setup. Japanese Unexamined Patent Publication No. 2021-13140 According to the configuration described in the publication, setting can be completed easily and quickly.

### SUMMARY OF THE INVENTION

The function of guiding the user by presenting various kinds of settings in a wizard format at the time of initial setup includes import processing for taking over the setting contents of the preceding apparatus. In a case where the predecessor machine is its own machine, it is possible to import the address information and the setting information (such as server information) necessary for the function using the address information. On the other hand, when the predecessor machine is a machine of another company, the address information can be imported. However, in a case where the predecessor apparatus is an apparatus of another company, other server information or the like cannot be simply imported because the setting content and the hierarchy are different for each company. Therefore, even if only address information is imported in initial setup at the time of replacement from an apparatus of another company, it is necessary to manually set setting information necessary for a function that uses address information. However, there is a problem in that the user does not easily know what needs to be set. Alternatively, there is a problem in that although content that needs to be set is known, it is not easy to know which screen is to be used for setting.

The configuration described in Japanese Unexamined Patent Publication No. 2006-139422 is a configuration in which setup is performed in accordance with user's answers to a plurality of question items. That is, the configuration described in Japanese Unexamined Patent Publication No. 2006-139422 is not a configuration in which necessary setting contents are determined in accordance with setting information imported from the preceding machine, and therefore, there is a problem in that appropriate setup cannot be performed at the time of replacement from the preceding machine.

The configuration described in Japanese Unexamined Patent Publication No. 2021-13140 is a configuration in which a setting value practically used in another image forming apparatus is indicated as a recommended setting value. That is, since the configuration described in Japanese Unexamined Patent Publication No. 2021-13140 is not a configuration of determining whether or not the setting related to the setting information imported from the preceding apparatus is necessary, there is a problem that appropriate setup cannot be performed at the time of replacement from the preceding apparatus.

An object of the present disclosure is to provide an image forming apparatus, a setting management method, and a program capable of easily completing appropriate setup at the time of initial setup at the time of replacement with a preceding apparatus.

To achieve at least one of the abovementioned objects, according to an aspect of the present invention, image forming apparatus reflecting one aspect of the present invention comprises a hardware processor that:
acquires setting information set in another image forming apparatus;
sets the acquired setting information;
determines whether or not setting of a setting item related to the acquired setting information is necessary; and
prompts setting of a setting item for which setting is determined to be necessary.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a diagram illustrating a schematic configuration of an image forming system according to the present embodiment;

FIG. 2 is a block diagram illustrating a functional configuration of the image forming system according to the present embodiment;

FIG. 3 is a diagram illustrating an example of a manner in which an initial setup sequence is presented in a wizard format;

FIG. 4 is a flowchart showing an example of the control of the image forming system according to the present embodiment

FIG. 5 is a flowchart illustrating an example of control when it is determined that an additional setting item is necessary;

FIG. 6 is a diagram illustrating an example of an address book file included in the setting information imported from the WWRSPF server;

FIG. 7 is a diagram illustrating an example in which the setting of the setting item determined to be required to be set is displayed as a message on the display part;

FIG. 8 is a diagram illustrating an example in which a wizard for setting a setting item determined to be required to be set is displayed on the display part;

FIG. 9 is a diagram illustrating an example in which the setting item determined to be required to be set is highlighted on the display part; and

FIG. 10 is a diagram illustrating another example in which the setting item determined to be required to be set is highlighted on the display part.

### DETAILED DESCRIPTION

Hereinafter, embodiment of the present disclosure will be described in detail with reference to the drawings. However, the scope of the invention is not limited to the disclosed embodiments.

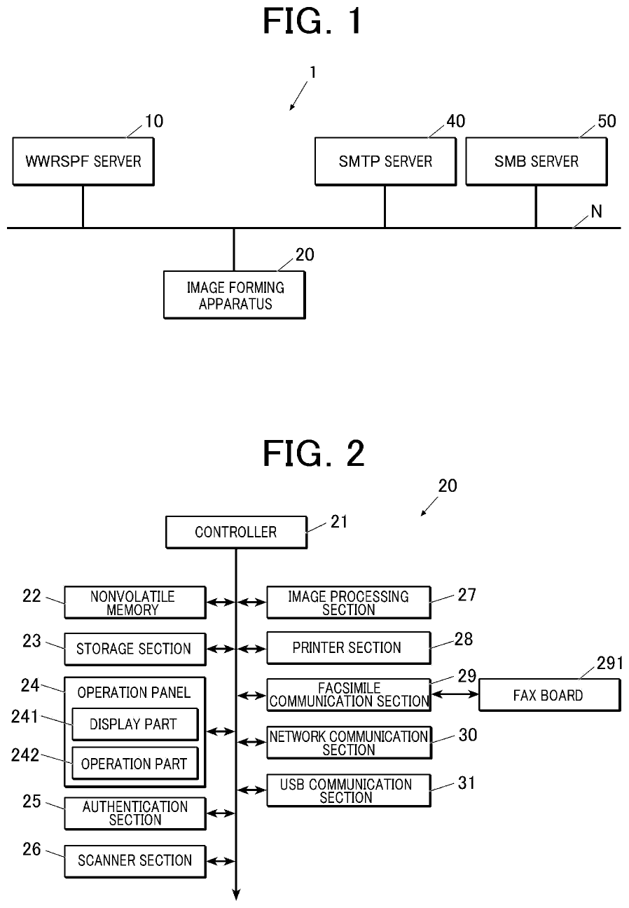

As illustrated in FIG. 1, the image forming system 1 according to the present embodiment includes a WWRSPF server 10, an image forming apparatus 20, an SMTP server 40, an SMB server 50, and the like. Each device constituting the image forming system 1 is connected to a network N. The communication network N is, for example, the Internet, a telephone line network of a telecommunications carrier, or a mobile phone communication network.

The WWRSPF server 10 is a computer device that manages setting information of each of the image forming apparatus 20 that cooperate with each other. The WWRSPF server 10 is used to take over the setting information of the preceding apparatus at the time of replacing the image forming apparatus 20.

The image forming apparatus 20 is a MFP having a plurality of functions. The plurality of functions include, for example, a copy function, a printer function, a scanner function, and a FAX function. Furthermore, the image forming apparatus 20 has a function of searching on a network with a web browser function via the operation panel 24.

As illustrated in FIG. 2, the image forming apparatus 20 includes a controller 21 (hardware processor), a nonvolatile memory 22, a storage section 23, an operation panel 24, an authentication section 25, a scanner unit 26, an image processing section 27, a printer section 28, a facsimile communication section 29, a network communication section 30, and a USB communication section 31.

The controller 21 includes a CPU, a ROM, and a RAM. The CPU comprehensively controls operation of each part of the image forming apparatus 20 based on a program stored in the ROM. The RAM is used as a work memory for temporarily storing various data when the CPU executes the program. The RAM is also used as an image memory for temporarily storing image data.

For example, the controller 21 acquires setting information (handover information) set in the preceding apparatus (another image forming apparatus 20). To be specific, the controller 21 imports and acquires, from the server 10, the setting information set on the preceding machine. That is, the controller 21 functions as an acquisition section of the present disclosure.

Further, the controller 21 sets the setting information acquired by the acquisition section. That is, the controller 21 functions as a setting section of the present disclosure.

The nonvolatile memory 22 is a memory in which memory is held even when power is turned off. The nonvolatile memory 22 stores information unique to the apparatus, various types of setting information, user authentication information, display data for various screens to be displayed on the display part 241 (display), and the like. The nonvolatile memory 22 also stores setting information when the setting of the precedent machine is taken over.

The storage section 23 is a hard disk device and stores various kinds of saved data. The storage section 23 stores image data acquired by reading a document in scanning or copying of the document. The storage section 23 stores print data (image data) included in a print job received and requested from a terminal (not illustrated). The storage section 23 stores received facsimile data and image data attached to an e-mail. The storage section 23 is also connected to an external storage device (not illustrated) and stores input image data and the like.

The operation panel 24 includes a display part 241 that displays various information to a user and an operation part 242 that receives an operation input from the user.

The display part 241 is constituted by a color liquid crystal display or the like. The display part 241 displays various screens according to a display control signal input from the controller 21. The various screens are, for example, an operation screen, a setting screen, a confirmation screen, a notification screen, a web browser screen, various buttons, an operating status of each function, and the like. In one aspect, one operation screen has at least one operation button. The operation buttons are also referred to as software keys, software buttons, selectable objects, and icons. A user of the image forming apparatus 20 can set an item, change a currently set item, and the like by operating the operation button. On the web browser screen, a search operation on the web can be performed.

The operation part 242 includes a touch screen provided on the screen of the display part 241 and various hard keys arranged around the screen of the display part 241. The various hard keys include, for example, a mode selection key for selecting an operation mode (job type) of a job to be set, a start key, a stop key, a cancel key, and a numeric keypad. When a button displayed on the screen is pressed by a finger, a touch pen, or the like, first, the operation part 242 detects coordinates of the pressed position by a voltage value. Next, the operation part 242 outputs, to the controller 21, a signal associated with the detected position. Note that the touch screen is not limited to a pressure-sensitive type, but may be, for example, an electrostatic type, an optical type, or the like. When hard keys are pressed, the operation part 242 outputs an operation signal associated with the pressed key to the controller 21.

The authentication section 25 compares the authentication information input by the user with the authentication information for verification stored in the nonvolatile memory 22 to identify (specify) and authenticate the user. Thus, it is possible to recognize which user has succeeded in authentication.

The scanner section 26 acquires image data by optically reading a document. The scanner section 26 includes a light source, a line image sensor, a moving unit, an optical path, and a conversion section. The light source irradiates the document with light. The line image sensor receives reflected light from the document and reads one line of the document in the width direction. The moving means sequentially moves the reading position for each line in the length direction of the document. The optical path includes lenses and mirrors, and guides reflected light from the document to the line image sensor to form an image. The conversion section converts the analog image signal output from the line image sensor into digital image data.

The image processing section 27 performs a rasterizing process on print data (vector-format print data) received from a terminal. The image processing section 27 performs various kinds of image processing, such as image correction, rotation, enlargement/reduction, and compression/decompression, on image data.

The printer section 28 forms an image based on image data on a recording sheet by an electrophotographic process and outputs the recording sheet. The printer section 28 includes a recording paper conveyance device, a photosensitive drum, a charging device, an LD, a scanning unit, a developing device, a transfer separation device, a cleaning device, and a fixing device. LD(Laser Diode) The light sources are controlled to be turned on in accordance with input image data. The scanning unit scans the laser beam emitted from the LD on the photosensitive drum. The printer section 28 is configured as a so-called laser printer. Note that the printer section 28 may be an LED printer that irradiates a photosensitive drum with a light emitting diode (LED) instead of laser light or a printer of another type.

The communication section 29 transmits and receives image data to and from an external device (not shown) having a facsimile function via a public line under the control of the FAX board 291 that provides the facsimile function.

The communication section 30 communicates with an external device through a network such as a local area network (LAN). For example, the network communication section 30 receives, from the WWRSPF server 10, the takeover information from the predecessor machine. The network communication section 30 transmits setting information of its own device to the WWRSPF server 10. Furthermore, the network communication section 30 transmits an electronic mail (E-mail) to the SMTP server 40. Further, the network communication section 30 performs SMB transmission to the SMB server 50. The SMB transmission is a function of converting document data read by the scanner section 26 or the like into a file which can be handled by a computer, and transmitting the file to a shared folder of the SMB server 50.

The USB communication section 31 transmits to and receives from a USB memory (not illustrated). For example, the USB communication section 31 receives the takeover information from the predecessor machine from the USB memory. The USB communication section 31 transmits the setting information of the own apparatus to the USB memory.

The SMTP server 40 sends an electronic mail (E-mail) to a destination on the communication network N. The SMTP server 40 also receives an e-mail for transmission from the network communication section 30.

The server 50 is a network server that stores shared resources (document data and the like) transmitted from the image forming apparatus 20 and the like on the communication network N.

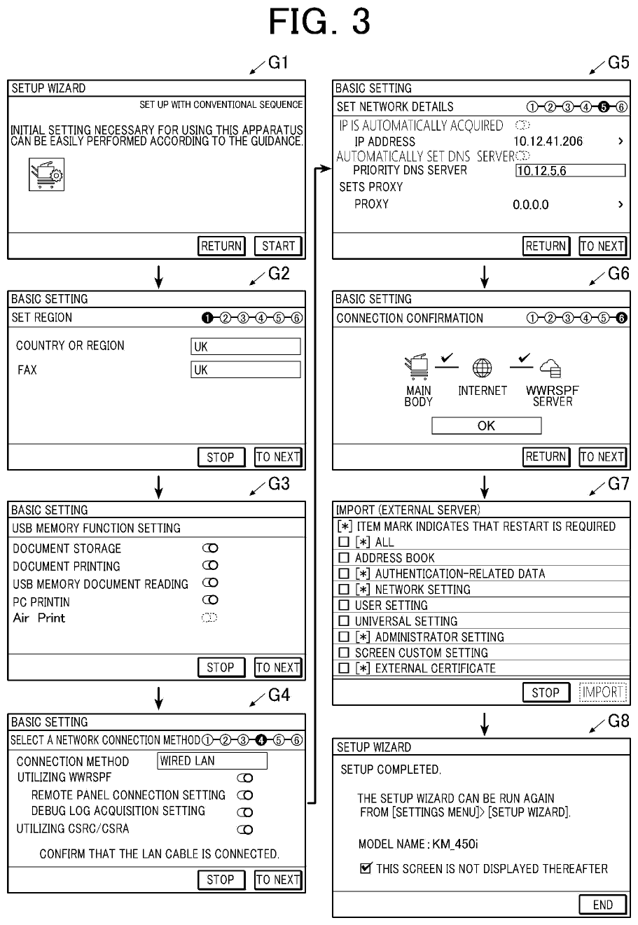

FIG. 3 is a diagram showing an example of a state in which an initial setup sequence is presented in a wizard format. In the example illustrated in FIG. 3, in each sequence, a predetermined screen is displayed on the display part 241.

First, a screen G1 for selecting start of the setup wizard is displayed (sequence 1). The user can select whether or not to start the setup wizard on the screen G1.

When start of the setup wizard is selected, screen G2 for selecting a region in which the own device is used is displayed (sequence 2).

Next, screen G3 for setting a function to use a USB memory is displayed (sequence 3).

Next, a screen G4 for selecting a network connection method is displayed (sequence 4). The user can select connection to the WWRSPF server 10 on the screen G4.

Next, screen G5 for setting details (IP address and the like) of the network is displayed (sequence 5).

Next, screen G6 for confirming network connection is displayed (sequence 6).

Next, screen G7 for selecting information to be subjected to import processing from the external server is displayed (sequence 7). On this screen G7, the user can select the contents (setting information) to be taken over from the antecedent machine.

Finally, screen G8 for providing notification that the setup by the setup wizard has been completed is displayed (sequence 8).

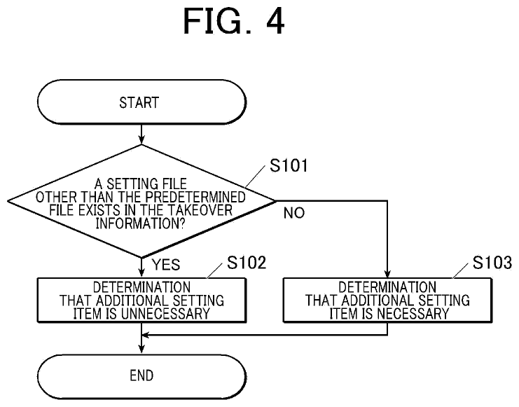

Next, control of the image forming system 1 according to the present embodiment will be described with reference to the flowchart of FIG. 4.

First, the controller 21 of the image forming apparatus 20 determines whether there is a setting file other than the predetermined file in the setting information (takeover information) imported from the WWRSPF server 10 (step S101). Here, the predetermined files are an address book file and an authentication-related data file.

When determining that a setting file other than the predetermined file exists (step S101:YES), the controller 21 proceeds to the next step S102.

On the other hand, if the controller 21 determines that no setting file other than the predetermined file exists (step S101:NO), the controller proceeds to step S103.

In step S102, the controller 21 determines that the preceding apparatus is highly likely to be its own apparatus, and determines that no additional setting item is required. Here, the additional setting items are setting items related to the setting information imported from the WWRSPF server 10.

In step S103, the controller 21 determines that the predecessor apparatus is highly likely to be an apparatus of another company, and determines that additional setting item is required.

As described above, the controller 21 determines whether or not the setting of the setting item related to the setting information acquired by the acquisition section is necessary. That is, the controller 21 functions as a decision section of the present disclosure.

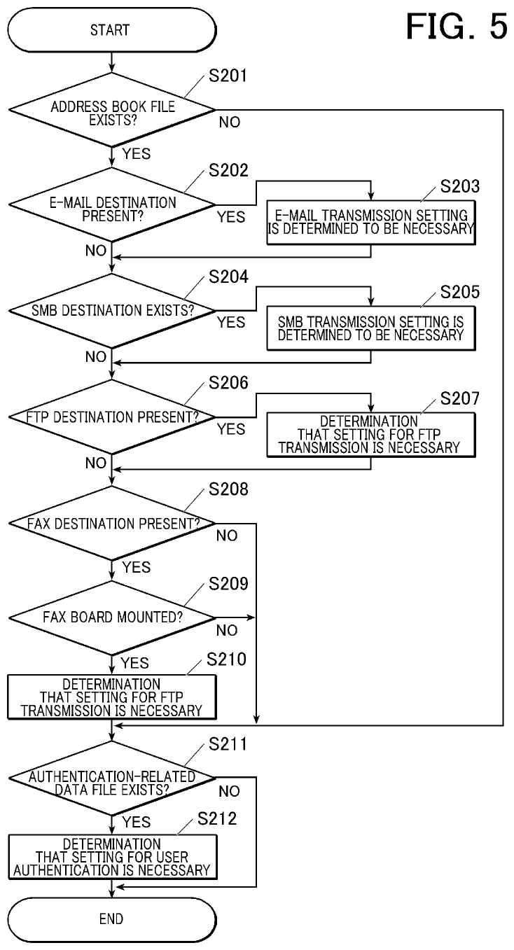

Next, referring to the flowchart of FIG. 5, a description will be given of control performed when it is determined in step S103 of FIG. 4 that an additional setting item is required.

First, the controller 21 determines whether or not an address book file (address information) exists in the setting information (takeover information) imported from the WWRSPF server 10 (step S201).

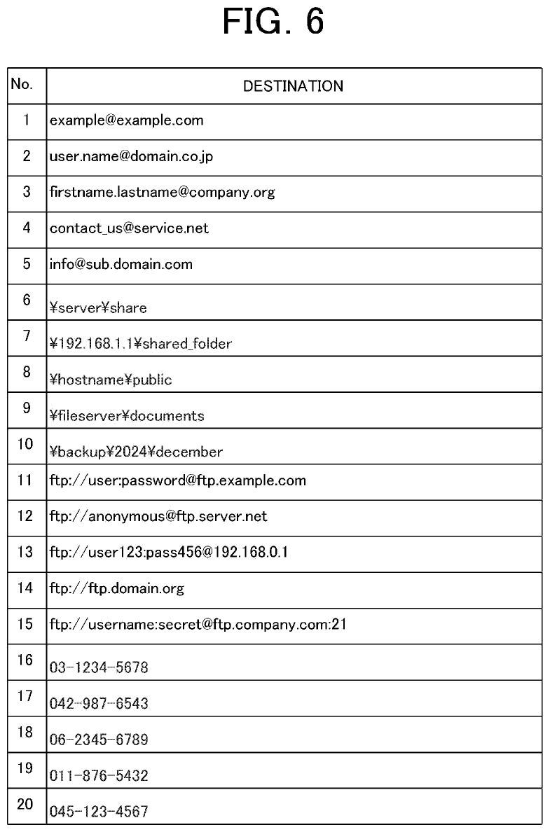

FIG. 6 illustrates an example of an address book file included in the setting information imported from the WWRSPF server 10. Nos. 1 to 5 in the address book file are examples of destinations for E-mail transmission (E-mail destinations). Nos. 6 to 10 of the address book file are examples of destinations for SMB transmission (SMB destinations). Nos. 11 to 15 of the address book file are examples of destinations for FTP transmission (FTP destinations). FTP transmission (FTP destinations). Nos. 16 to 20 of the address book file are examples of destinations for FAX transmission (FAX destinations).

When determining that a file exists (step S201:YES), the controller 21 proceeds to the next step S202.

On the other hand, when determining that the address book file does not exist (step S201:NO), the controller 21 proceeds to step S211.

In step S202, the controller 21 determines whether an e-mail destination exists in the address book file. For example, the controller 21 determines whether an e-mail destination exists according to whether each destination included in the address book file corresponds to a regular expression of an e-mail destination.

The regular expression of the e-mail destination is \hat{ }[a-zA-Z0-9._%+-] +@[a-zA-Z0-9.-]+\.[a-zA-Z]{2,}$.\hat{ }indicates the beginning of a character string. [a-zA-Z0-9._%+-]+ indicates a portion in which any one of alpha-numeric characters, a dot (.), an underscore (_), a percentage (%), a plus (+) , and a hyphen (-) continues once or more. [a-zA-Z0-9.-] + represents a portion in which any one of alpha-numeric characters, a dot (.), and a hyphen (-) continues one or more times. \. indicates that a dot (.) is allowed to escape and be recognized as a character. The [a-zA-Z]{2,} indicates a portion where two or more letters continue. $ indicates the end of the character string.

If the controller 21 determines that an e-mail destination exists in the address book file (step S202: YES), the controller 21 proceeds to the next step S203.

On the other hand, when determining that an e-mail destination does not exist in the address book file (step S202:NO), the controller 21 proceeds to step S204.

In step S203, the controller 21 determines that setting for e-mail transmission is necessary. Thereafter, the process proceeds to step S204.

In step S204, the controller 21 determines whether an SMB destination exists in the address book file. For example, the controller 21 determines whether an SMB destination exists according to whether each destination included in the address book file corresponds to a regular expression of the SMB destination.

The regular expression of the SMB destination is: \hat{ }\\\\[a-zA-Z0-9._-] +\\[a-zA-Z0-9$_.-] +(\\[a-zA-Z0-9$_.-] +)*$. \hat{ } indicates the start of a character string. \\\\indicates that backslash (¥) is escaped and expressed with two consecutive backslash (¥) s (head part of the SMB path). [a-zA-Z0-9._-] + is a hostname or IP-address part, and indicates a part where alpha-numeric characters, a dot (.), an underscore (_), and a hyphen (-) continue one or more times. \\indicates that a backslash (¥) is escaped to express one. [a-zA-Z0-9$_.-] + is a shared name part and indicates a part in which alpha-numeric characters, a dollar sign ($), an underscore (_), a dot (.), and a hyphen (-) continue one or more times. (\\[a-zA-Z0-9 $_.-] +) * is an optional subdirectory portion, and indicates a portion in which a backslash (¥) is followed by an alpha-numeric character, a dollar sign ($), an underscore (_), a dot (.), and a hyphen (-) 0 times or more. $ indicates the end of the character string.

When determining that an SMB destination exists in the address book file (step S204:YES), the controller 21 proceeds to the next step S205.

On the other hand, when determining that no SMB destination exists in the address book file (step S204:NO), the controller 21 proceeds to step S206.

In step S205, the controller 21 determines that the setting for SMB transmission is necessary. Thereafter, the process proceeds to step S206.

In step S206, the controller 21 determines whether an FTP destination exists in the address book file. For example, the controller 21 determines whether an FTP destination exists, based on whether each destination included in the address book file corresponds to a regular expression of an FTP destination.

The regular expression of the FTP destination is \hat{ }ftp \/\/[a-zA-Z0-9._-] +(:[a-zA-Z0-9._-]+)? @ [a-zA-Z0-9.-]+\.[a-zA-Z] {2,} (:[0-9]+)? (\/[a-zA-Z0-9._-]+)*\/?$.\hat{ } indicates the start of a character string. ftp:\/\/Indicates to escape and express a character string of ftp://.[a-zA-Z0-9._-] + is a user name part and indicates a part in which alphanumeric characters, a dot (.), an underscore (_), and a hyphen (-) continue one or more times. (:[a-zA-Z0-9._-]+)? is an optional password part, which indicates a part where a colon (:) is followed by alpha-numeric characters, a dot (.), an underscore (_), and a hyphen (-) zero times or once. @[a-zA-Z0-9.-]+ indicates a hostname or IP-address portion following an at mark (@), in which alpha-numeric characters, a dot (.), and a hyphen (-) continue one or more times. \.[a-zA-Z] {2,} indicates a portion (domain name) where a dot (.) is followed by two or more English letters. (:[0-9]+)? is an optional port number portion, and indicates a portion in which a number follows a colon (:) 0 times or once. (\/[a-zA-Z0-9._-]+) * is an optional path part and indicates a part in which a slash (/) is followed by alpha-numeric characters, a dot (.), an underscore (_), and a hyphen (-) for zero or more times. \/? indicates a slash (/) at the end of the option. $ indicates the end of the character string.

When determining that an FTP destination exists in the address book file (step S206:YES), the controller 21 proceeds to the next step S207.

On the other hand, when determining that no FTP destination exists in the address book file (step S206:NO), the controller 21 proceeds to step S208.

In step S207, the controller 21 determines that setting for FTP transmission is necessary. Thereafter, the process proceeds to step S208.

In step S208, the controller 21 determines whether a FAX destination exists in the address book file. For example, the controller 21 determines whether the FAX destination exists according to whether each destination included in the address book file corresponds to a regular expression of the FAX destination.

The regular expression of the FAX destination is \hat{ }0\d{1,4}-\d{1,4}-\d{4}$.\hat{ } indicates the beginning of a character string. 0¥d{1,4} indicates an area code (1 to 4 digits). ¥d{1,4} indicates a local area code (1 to 4 digits). ¥d{4} indicates a subscriber number (four digits). $ indicates the end of the character string.

When determining that a FAX destination exists in the address book file (step S208:YES), the controller 21 proceeds to the next step S209.

On the other hand, when determining that the FAX destination does not exist in the address book file (step S208:NO), the controller 21 proceeds to step S211.

In step S209, the controller 21 determines whether or not the FAX board 291 is attached.

When determining that the FAX board 291 is attached (step S209:YES), the controller 21 proceeds to the next step S210.

On the other hand, when determining that the FAX board 291 is not attached (step S209:NO), the controller 21 proceeds to step S211.

In step S210, the controller 21 determines that setting for FAX transmission is necessary. Thereafter, the process proceeds to step S211.

In step S211, the controller 21 determines whether an authentication-related file exists in the setting information (handover information) imported from the server 10.

When determining that an authentication-related file exists (step S211:YES), the controller 21 proceeds to the next step S212.

On the other hand, when determining that no authentication-related file exists (step S211:NO), the controller 21 ends the processing.

In step S212, the controller 21 determines that setting for user authentication is necessary. Thereafter, the process is terminated.

As described above, if the controller 21 determines that the setting information acquired by the acquisition section includes address information, the controller 21 determines that it is necessary to set a setting item associated with the address information. The settings of the setting item related to the address information are, for example, settings for E-mail transmission (E-mail setting), settings for SMB transmission (SMB setting), settings for FTP transmission (FTP setting), settings for FAX transmission (FAX setting), and the like.

Furthermore, if the controller 21 determines that the setting information acquired by the acquisition section includes user information, the controller 21 determines that it is necessary to set a setting item related to user authentication. The setting of the setting item related to user authentication is, for example, setting for user authentication.

Furthermore, the controller 21 makes the determination in consideration of the mounting state of the option. The option is, for example, the FAX board 291. That is, the controller 21 determines whether or not the setting for FAX transmission is necessary in consideration of the mounting state of the FAX board 291.

Thereafter, the controller 21 prompts the user to set the setting item determined to be required to be set by the decision section. That is, the controller 21 functions as a presenter of the present disclosure.

For example, the controller 21 causes the display part 241 to display, as a message, the setting of the setting item determined to be required to be set by the decision section.

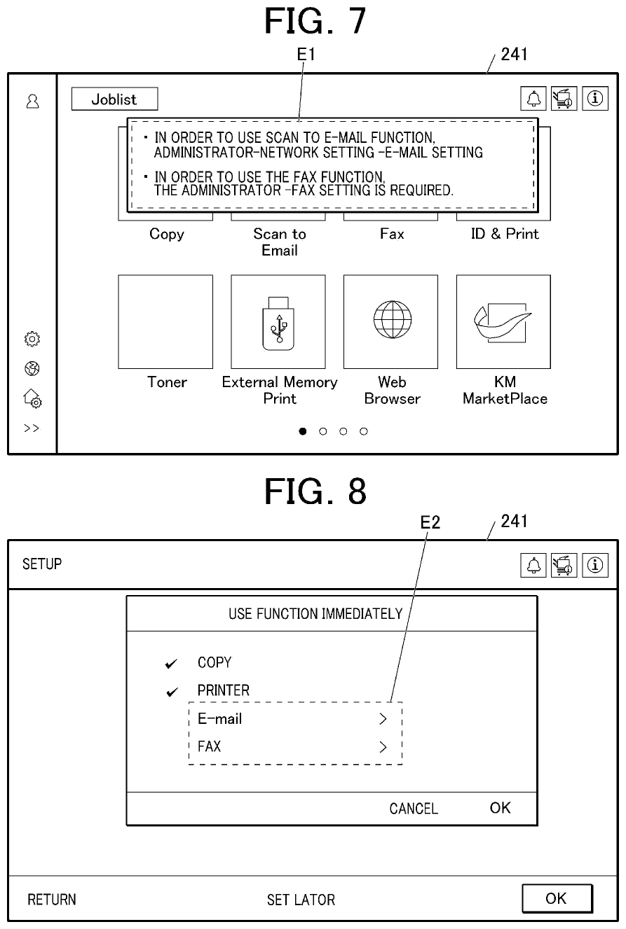

FIG. 7 illustrates an example in which setting of a setting item determined to be required to be set is displayed as a message on the display part 241. In the example illustrated in FIG. 7, an example of a case where an e-mail destination and a FAX destination are included in the address book file is illustrated. To be specific, in FIG. 7, a message prompting E-mail setting and FAX setting related to the E-mail destination and the FAX destination, respectively, is displayed (see reference sign E1). In this way, the setting of the setting item determined to be required to be set can be presented to the user in a pinpoint manner.

As described above, the image forming apparatus 20 according to the present embodiment includes an acquisition section (controller 21), a setting section (controller 21), a decision section (controller 21), and a presenter (controller 21). The acquisition section acquires setting information that has been set in another image forming apparatus. The setting section sets the setting information acquired by the acquisition section. The decision section determines whether or not the setting of the setting item related to the setting information acquired by the acquisition section is necessary. The presenter prompts the user to set the setting item determined to be required to be set by the decision section.

Therefore, the image forming apparatus 20 according to the present embodiment can promote the setting of the setting item determined to be necessary in accordance with the import information from the preceding apparatus. Therefore, it is possible to easily complete an appropriate setup at the time of an initial setup at the time of replacement from the precedent machine.

Furthermore, the decision section makes a determination in consideration of the mounting state of the option (the FAX board 291).

Therefore, even for a setting item that is determined to be necessary according to the import information from the preceding apparatus, setting of an unusable function can be omitted. For example, even if it is determined that FAX setting is necessary, the FAX setting can be omitted in a case where FAX transmission cannot be performed because the FAX board 291 is not attached. Therefore, it is possible to reduce time and effort of the user.

Further, when it is determined that the address information is included in the setting information acquired by the acquisition section, the decision section determines that the setting of the setting item related to the address information is necessary. In addition, when determining that the setting information acquired by the acquisition section includes user information, the decision section determines that it is necessary to set a setting item related to user authentication.

Therefore, it is possible to determine whether or not the setting of the setting item necessary for the use of the function using the import content is necessary according to the import information from the precedent machine. Therefore, it is possible to easily perform appropriate setup at the time of initial setup at the time of replacement from the precedent machine.

Further, the presenter causes the display part 241 to display, as a message, the setting of the setting item determined to be required to be set by the decision section.

Therefore, the setting of the setting item determined to be necessary according to the import information from the precedent machine can be presented to the user in an easy-to-understand manner. Therefore, it is possible to easily complete an appropriate setup at the time of an initial setup at the time of replacement from the precedent machine.

Although specific description has been given above based on the embodiment according to the present disclosure, the present disclosure is not limited to the above-described embodiment, and changes can be made without departing from the spirit and scope of the present disclosure.

For example, although the setting of the setting item determined to be required to be set by the decision section is displayed as a message on the display part 241 in the embodiment described above, it is not limited thereto. For example, the controller 21 may cause the display part 241 to display a wizard for setting the setting item determined to be required to be set by the decision section.

FIG. 8 illustrates an example in which a wizard for setting a setting item determined to be required to be set is displayed on the display part 241. In the example illustrated in FIG. 8, an example in which an e-mail destination and a FAX destination are included in the address book file is illustrated. Specifically, in FIG. 8, a wizard for performing e-mail setting and FAX setting related to an e-mail destination and a FAX destination, respectively, is displayed (see reference numeral E2). The wizard shown in FIG. 8 may be inserted immediately before the completion of the initial setup procedure shown in FIG. 3 (between sequence 7 and sequence 8).

As described above, the presenter causes the display part 241 to display a wizard for setting the setting item determined to be required to be set by the decision section.

Therefore, it is possible to support the setting by the user while intelligibly presenting the setting of the setting item determined to be necessary according to the import information from the preceding machine to the user. Therefore, it is possible to easily complete an appropriate setup at the time of an initial setup at the time of replacement from the precedent machine.

Further, the controller 21 may cause the display part 241 to highlight the setting item determined to be required to be set by the decision section.

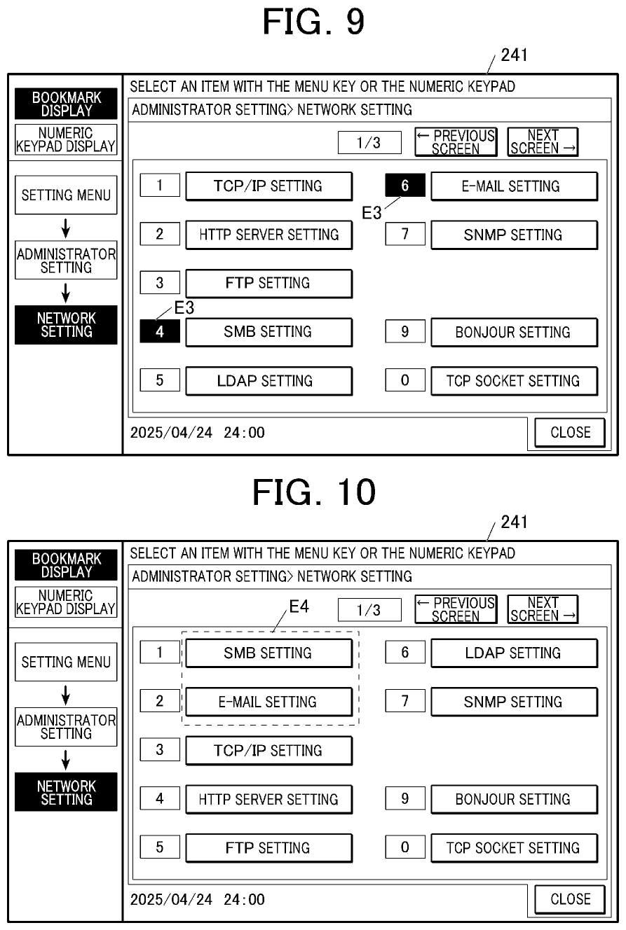

FIG. 9 illustrates an example in which a setting item determined to be required to be set is highlighted on the display part 241. In the example illustrated in FIG. 9, an example in which an e-mail destination and an SMB destination are included in the address book file is illustrated. Specifically, in FIG. 9, the setting item and the SMB setting item respectively related to the E-mail destination and the SMB destination among the setting items of the existing network setting are highlighted by changing the color of the number portion (refer to reference numeral E3).

FIG. 10 illustrates another example in which the setting item determined to be required to be set is highlighted on the display part 241. In the example illustrated in FIG. 10, an example of a case where an e-mail destination and an SMB destination are included in the address book file is illustrated. To be specific, in FIG. 10, the order of the item of the E-mail setting and the item of the SMB setting related to the E-mail destination and the SMB destination, respectively, is moved up so as to be highlighted (see the reference sign E4).

Note that instead of changing the order of the setting items, only the setting item determined to be required to be set may be displayed on the display part 241 so as to be highlighted.

As described above, the presenter causes the display part 241 to highlight the setting item determined to be required to be set by the decision section.

Therefore, the setting of the setting item determined to be necessary according to the import information from the precedent machine can be presented to the user in an easy-to-understand manner. Therefore, it is possible to easily complete an appropriate setup at the time of an initial setup at the time of replacement from the precedent machine.

Further, in the above-described embodiment, in the control of FIG. 6, it is identified whether or not the E-mail destination, the SMB destination, the FTP destination, and the FAX destination are included in the address book information, but the present invention is not limited thereto. A configuration may be adopted in which a destination other than the above-described destinations is identified, and in a case where the destination exists, it is determined that the setting for the destination is necessary.

Furthermore, although the above embodiment is described with the example of the configuration in which the image forming system 1 includes the SMTP server 40 and the SMB server 50 in addition to the WWRSPF server 10 and the image forming apparatus 20, it is not limited thereto. For example, a configuration may be adopted in which an FTP server is provided in addition to the above-described configuration. Here, the server is a server that transmits and receives files using FTP. The image forming system 1 can provide a function of FTP transmission by including the FTP server.

In addition, the detailed configuration of each device and the detailed operation of each device constituting the image forming system can also be appropriately changed without departing from the spirit and scope of the present disclosure.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image forming apparatus comprising a hardware processor that:
acquires setting information set in another image forming apparatus;
sets the acquired setting information;
determines whether or not setting of a setting item related to the acquired setting information is necessary; and
prompts setting of a setting item for which setting is determined to be necessary.

2. The image forming apparatus according to claim 1, wherein the hardware processor determines whether or not the setting of the setting item related to the acquired setting information is necessary in consideration of a mounting state of an option.

3. The image forming apparatus according to claim 1, wherein in response to determination that address information is included in the acquired setting information, the hardware processor determines that setting of a setting item related to the address information is necessary.

4. The image forming apparatus according to claim 1, wherein in response to determination that the acquired setting information includes user information, the hardware processor determines that setting of a setting item related to user authentication is necessary.

5. The image forming apparatus according to claim 1, wherein the hardware processor causes a display to display a message indicating the setting of the setting item for which the setting is determined to be necessary.

6. The image forming apparatus according to claim 1, wherein the hardware processor causes a display to display a wizard for setting the setting item for which the setting is determined to be necessary.

7. The image forming apparatus according to claim 1, wherein the hardware processor causes a display to highlight and display the setting item for which the setting is determined to be necessary.

8. A setting management method for an image forming apparatus, the method comprising:
acquiring that is acquiring setting information set in another image forming apparatus;
setting that is setting the setting information acquired in the acquiring;
determining that is determining whether or not setting of a setting item related to the setting information acquired in the acquiring is necessary; and
presenting that is prompting to set a setting item for which setting is determined to be necessary in the determining.

9. A non-transitory computer-readable storage medium storing a program for causing a computer of an image forming apparatus to perform:
acquiring that is acquiring setting information set in another image forming apparatus;
setting that is setting the setting information acquired in the acquiring;
determining that is determining whether or not setting of a setting item related to the setting information acquired in the acquiring is necessary; and
presenting that is prompting to set a setting item for which setting is determined to be necessary in the determining.
